(19) United States
(12) Patent Application Publication
(10) Pub. No.: US 2005/0190741 A1
(43) Pub. Date: Sep. 1, 2005

(54) Autonomous communication system

(76) Inventor: Martin Pettersson, Nacka (SE)

Correspondence Address: Swidler Berlin;Shereff Friedman, Suite 300, 3000 K Street NW, Washington, DC, 20007, US

(21) Appl. No.: 10/518,906

(22) PCT Filed: Jun. 12, 2003
(86) PCT No.: PCT/SE03/00978

§ 371 Date: Dec. 23, 2004

(30) Foreign Application Priority Data
Jun. 26, 2002 (SE) 0201974-3

(51) Int. Cl. H04B 7/212

(52) U.S. Cl. 370/350; 370/348

(57) ABSTRACT

The invention relates to communication of data in a time division multiple access system where the data is transmitted wirelessly between station (MS1-MS6; BS1-BS3) in time slots. The time slots are arranged in frames of a repeating frame structure. The stations (MS1-MS6; BS1-BS3) autonomously select time slots for transmission of data according to a self-organizing transmission algorithm, which allows a first station (MS1) to reuse a time slot that is allocated to a second station (MS2-MS6, BS2, BS3). According to the invention an addressed message (M^{M1}_{Adr}) is sent from a first base station (BS1) to a mobile station (MS1). This station transmits am acknowledgement message (Ack^{M1}_{B1}) in response to the addressed message (M^{M1}_{Adr}) in order to confirm a safe receipt of the addressed message (M^{M1}_{Adr}). If due to for example a high traffic load, the acknowledgement message (Ack^{M1}_{B1}) cannot be received directly by the first base station (BS1), the mobile station (MS1) sends this message (Ack^{M1}_{B1}) via a second base station (BS2) to a message handling entity (MHE) in a network (N), which is responsible for the transmission of the addressed message (M^{M1}_{Adr}). The message handling entity (MHE) may either be a separate node in the network (N) or be included in the first station (BS1). Thanks to the proposed solution, unnecessary repeated transmissions of the addressed message (M^{M1}_{Adr}) can be avoided, and consequently valuable wireless bandwidth be saved.

### THE BACKGROUND OF THE INVENTION AND PRIOR ART

The present invention relates generally to a solution in a communication system where the communication resources are organized autonomously between the communicating parties. More particularly the invention relates to a method for communicating data in a time division multiple access system according to the preamble of claim 1, a computer program according to claim 7, a computer readable medium according to claim 8, a message handling entity according to claim 9 and a base station according to the preamble of claim 10.

The most typical examples of autonomous communication systems are the recent communication, navigation and surveillance (CNS) systems, which aim at replacing or at least complementing traditional radar systems in aviation and maritime traffic administrations. For instance, the U.S. Pat. No. 5,506,587 discloses such a position indicating system.

The CNS-systems are based on a global navigation satellite system (GNSS), such as the U.S. GPS (Global Positioning System) and the Russian correspondence GLONASS (Global Navigation Satellite System), which allows a vessel to establish its own position anywhere on the globe. In a CNS-system, each vessel is equipped with a station that includes a position sensor (typically a GNSS receiver). The station can thereby continuously receive information pertaining to its own position. Furthermore, it repeatedly broadcasts this information on a VHF data link, such that other stations in vicinity thereof can be updated with this position information. Due to the dynamics of the system and the inherent unpredictability of the stations' behaviour, the position information is preferably exchanged between the stations according to a so-called SOTDMA-standard (Self-Organized Time Division Multiple Access).

An SOTDMA-system of this type combines the line-of-sight characteristics of VHF radio frequencies with a very accurate timing from a GNSS receiver and a self-organizing transmission algorithm to create a data link for exchanging the position information. In certain areas the data link may have to be shared among a very large number of stations. The purpose of the self-organizing transmission algorithm is to allow short transmissions (so-called bursts, which are organized in time slots) from each of these stations, while minimizing the risk of transmission conflicts. The stations themselves control the usage of the transmission resources, i.e. without any external controlling or polling functions from a master control entity.

The ITU-R standard M.1371-1, document 8/BL/5-E, 19 Apr. 2001 describes an algorithm which, under certain conditions, allows a first station to reuse a time slot that is actually allocated to a second station. Although this policy generally is preferable there exist some problematic situations. For instance, an addressed message from a base station to a mobile station in response to which the mobile station must return an acknowledgement message in order to conform a safe receipt of the addressed message may cause the base station to produce a series of unnecessary retransmissions of this message. Due to the mobile station's lower priority in relation to the base stations, a base station may namely be able to reach a particular mobile with such an addressed message, however because of a heavy traffic load, the mobile station may be prevented from returning a corresponding acknowledgement message. This in turn, will trigger a retransmission procedure in the base station, which further increases the traffic load without improving the situation for the mobile station. On the contrary, the mobile station's chances of returning the acknowledgement message are even further reduced.

### SUMMARY OF THE INVENTION

It is therefore an object of the present invention to alleviate the problems above and thus provide an improved solution for communicating data in an environment where the communicating parties may move unrestricted relative each other, where the transmission resources are allocated without the support of an external controlling or polling function and where a time slot allocated to a first station may be reused by a second station.

According to one aspect of the invention, this object is achieved by a method for communicating data in a time division multiple access system as described initially, which is characterized by receiving the acknowledgement message in a second base station. The acknowledgement message is then forwarded from the second base station to the message handling entity. The message handling entity is connected to a network to which both the first and the second base station are connected, either directly or via at least one intermediate node. Finally, the message handling entity receives the acknowledgement message via the network.

An important advantage attained by this strategy is that the first base station thereby can refrain from performing any unnecessary retransmissions of the addressed message. This, in turn, saves valuable transmission bandwidth in vicinity of the base station, such that these resources instead may be utilized for transmission of useful messages.

According to one preferred embodiment of this aspect of the invention, the acknowledgement message is forwarded via the network to the message handling entity, which in turn is located within the first base station. Such location of the message handling entity is advantageous because the network traffic is thereby kept on a low level.

According to another preferred embodiment of this aspect of the invention, the acknowledgement message is forwarded via the network to a node in the network, which is separated from the first base station. Such separation between the message handling entity and the base stations is desirable, since one message handling entity may thereby serve a plurality of base stations, which in turn vouches for flexibility and economy.

According to yet another preferred embodiment of this aspect of the invention, the self-organizing transmission algorithm only permits the first station to reuse a time slot that is allocated to a base station if the base station is located outside a threshold distance from the first station. Thereby, a certain minimum communication range is granted to the base station, which is beneficial because otherwise a base station in a heavily loaded area would risk becoming congested and thus incapable of communicating with the surrounding stations.

According to a preferred embodiment of this aspect of the invention, the self-organizing transmission algorithm permits the first station to reuse a time slot that is allocated to a mobile station, which is located at any distance from the first station. The transmission resources may thereby be utilized very efficiently in relatively crowded areas. Here, the communication range for each station only becomes as long as the circumstances allow. Typically, this means a range being considerably shorter than otherwise (i.e. where the station density is much lower). Since however, according to the invention, the mobile stations are also offered opportunities to send their acknowledgement messages via at least one alternative base station, the risk that a particular mobile station cannot send an acknowledgement message is reduced significantly. Any detrimental effects of the above reduction of the communication range are thereby lessened to a corresponding degree.

According to another aspect of the invention, this object is achieved by a computer program directly loadable into the internal memory of a digital computer, comprising software for controlling the method described above when said program is run on a computer.

According to yet another aspect of the invention, this object is achieved by a computer readable medium, having a program recorded thereon, where the program is to make a computer perform the proposed method.

According to still another aspect of the invention, this object is achieved by a message handling entity for controlling data communication between at least one base station and at least one mobile station in a time division multiple access system where the data is transmitted wirelessly between the stations in time slots. The time slots are organized in frames of a repeating frame structure. Moreover, the stations select time slots for transmission of data according to a self-organizing transmission algorithm, which allows a first station to reuse a time slot that is allocated to a second station. The message handling entity includes a memory area, a network interface and a central unit. The memory area is adapted to hold status information pertaining to an addressed message that is sent from a first base station to a particular mobile station. The network interface is adapted to (1) send a control message, which orders the first base station to transmit an, addressed message to the mobile station, (2) receive an acknowledgement message from a second base station (The acknowledgement message has here been generated by the mobile station in response to the addressed message, and been sent to the second base station), and (3) forward the acknowledgement message for processing in the message handling entity (i.e. in the central unit). The central unit, in turn, is adapted to (1) order retransmission of the addressed message from the first base station, if after a predetermined interval from the transmission of the addressed message, the status information remains intact in the memory area, (2) order repeated retransmissions of the addressed message up to a maximum number of times, and (3) receive the acknowledgement message, and in response thereto, clear the status information in the memory area.

This message handling entity is advantageous because it makes it possible to receive acknowledgement messages via other base stations than the base station from which a particular addressed message was originated. Thereby the originating base station may further be prevented from performing unnecessary retransmissions of the addressed message. This, in turn, saves valuable wireless bandwidth in vicinity of this base station, such that these resources instead may be utilized for other purposes.

According to yet another aspect of the invention, this object is achieved by a base station for communicating data with at least one other station in a time division multiple access system as described initially, which is characterized in that it comprises an interface towards a network to which at least one other base station is connected. The interface is adapted to receive acknowledgement messages from the at least one other base station and to forward any such messages to the central unit within the base station. This is advantageous because the base station is thereby able to receive acknowledgement messages via other base stations via the network, and may thus to a larger extent than otherwise refrain from performing unnecessary retransmissions of the addressed message. This, of course, saves valuable wireless bandwidth in vicinity of the base station, such that these resources instead may be utilized for other purposes.

According to a preferred embodiment of this aspect of the invention, the receiver is also adapted to receive acknowledgement messages in respect of at least one other base station. Furthermore, the interface is adapted to forward such acknowledgement messages to the respective at least one other base station via the network. Hence, the proposed solution becomes symmetrical, in that the base station may also assist other base stations in receiving their acknowledgement messages.

The proposed solution generally provides a very high data throughput in an autonomous communication system, such as an SOTDMA-system. Moreover, the invention provides a more stabile system state than the prior-art solutions, particularly at high local traffic loads. Naturally, the invention therefore grants a competitive edge to any communication system operating according to the proposed procedure.

It should be noted that the concept proposed by this invention is not limited to CNS-systems. On the contrary, the invention works very well in any dynamic environment, where a reliable delivery of relatively small amounts of information must be granted. The concept also handles overload very well, with graceful reduction of the throughput as a result.

### BRIEF DESCRIPTION OF THE DRAWINGS

The present invention is now to be explained more closely by means of preferred embodiments, which are disclosed as examples, and with reference to the attached drawings.

FIGS. 1a,b illustrate a frame and a slot structure in which data is transmitted according to an embodiment of the invention,

FIG. 2 shows a proposed structure of an individual time slot,

FIG. 3 shows a time line, which illustrates how the frame structures of different stations may be time-shifted relative each other according to a per se known resource allocation procedure,

FIG. 4 illustrates a per se known method of choosing a time slot for a transmission based on a selection interval,

FIG. 5 shows a terrain segment in which a plurality of stations communicate according to a first preferred embodiment of the invention,

FIG. 6 shows a sequence diagram, which reveals a problem being associated with a prior-art solution,

FIG. 7 shows a sequence diagram, which exemplifies a strategy of the invention according to the embodiment of the invention exemplified in FIG. 5,

FIG. 8 shows a block diagram over a proposed message handling entity,

FIG. 9 shows a terrain segment in which a plurality of stations communicate according to a second preferred embodiment of the invention,

FIG. 10 shows a sequence diagram, which exemplifies a strategy of the invention according to the embodiment of the invention exemplified in FIG. 9,

FIG. 11 shows a block diagram over a proposed base station,

FIG. 12 shows a first flow diagram, which summarizes a first aspect of the proposed method, and

FIG. 13 shows a second flow diagram, which summarizes a second aspect of the proposed method.

### DESCRIPTION OF PREFERRED EMBODIMENTS OF THE INVENTION

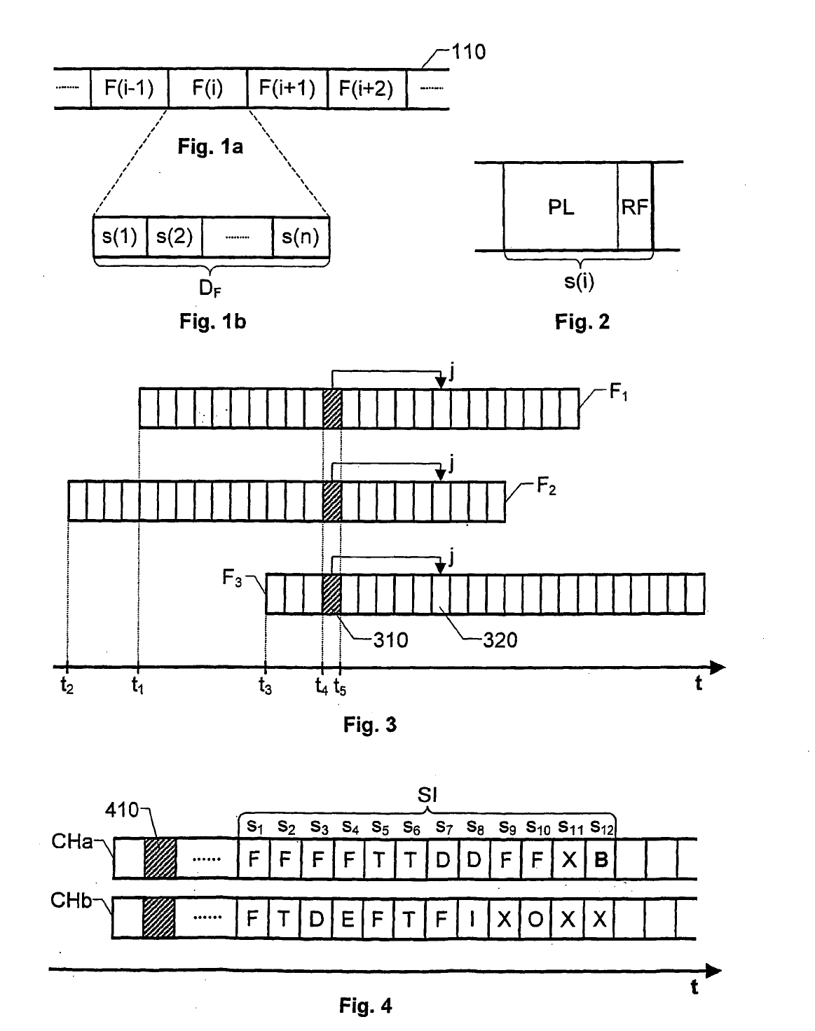

FIG. 1a illustrates a frame structure 110 including frames F(i−1), F(i), F(i+1), F(i+2) etc in which data may be transmitted between different stations according to an embodiment of the invention. Each of the frames F(i−1), F(i), F(i+1), F(i+2) is further divided into a plurality of time slots where a particular time slot re-occurs again in a following frame at the same position. Thus, the frame structure has a time-slot pattern, which is repeated once per frame interval.

FIG. 1b illustrates the contents of a particular frame F(i) in the frame structure 110 shown in FIG. 1a. The frame F(i) has a duration D_{F} where after the pattern is repeated and a following frame is initiated. In an SOTDMA-protocol for a CNS-system, the frame duration D_{F} is typically 1 minute and the frames are divided into 2250 time slots. Hence, each time slot approximately has a duration of 26.67 ms.

FIG. 2 shows how a time slot s(i) may be further divided into information fields according to an embodiment of the invention. Preferably the contents of each time slot s(i) is organized according to such format that at least one field PL transports payload data (e.g. position information and station identity) and at least one field RF transports reservation data. The at least one latter filed RF is thus used to indicate time slot reservations, which may involve a reuse of time slots already allocated to a different station.

FIG. 3 shows a time line, which illustrates how the frame structures F₁, F₂ and F₃ respectively of three different stations may be time-shifted relative each other. In this example a first frame structure F₁ starts at a first point in time t₁, a second frame structure F₂ starts at a second point in time t₂, and a third frame structure F₃ starts at a third point in time t₃, where t₂<t₁<t₃. (i.e. the second frame structure F₂ starts first and the third frame structure F₃ starts last). The different start times for the different frame structures F₁, F₂ and F₃ is, however, not a problem, since the time slot boundaries within the frames are synchronized between the different frame structures F₁, F₂ and F₃. Thus, a current time slot 310 will start at a specific point in time t₄ and end at a specific later point in time t₅ with respect to all stations irrespective of how each of these stations internally refers to the time slot 310. This time slot synchronization is accomplished by means of a signal from a common and very accurate external timing source, for instance a navigation satellite.

According to a preferred embodiment of the invention, a relative (rather than an absolute) measure is utilized to specify a future time slot 320. Specifically, this means that a relative slot increment j in respect of the current time slot 310 designates the future time slot 320.

FIG. 4 illustrates a per se known method of choosing a time slot for a transmission on basis of a selection interval. The figure exemplifies reservations made in a time slot structure of a channel pair CHa and CHb, which typically operates at two different carrier frequencies, say 161.975 MHz and 162.025 MHz respectively. According to a preferred embodiment of the invention, each station is adapted to receive both the channels CHa and CHb in parallel, i.e. the stations are characteristically equipped with at least two TDMA-receivers. Basically, both channels CHa and CHb are used for the same purposes, however normally in an alternating manner.

Periodic messages (such as initial link accesses) should alternate between the channels CHa and CHb respectively on a transmission by transmission basis, preferably without respect to the frame structure. Nevertheless, a response message is normally sent on the same channel as a corresponding initial message. Moreover, an addressed message should preferably be sent on the channel via which the last message from the addressed station was received. Other non-periodic messages should, in similarity with the periodic messages, also alternate between the channels CHa and CHb.

A base station may alter its transmission between the channels CHa and CHb in order to increase the link capacity, to balance the channel load between the channels CHa and CHb and/or to mitigate any harmful effects of radio interference. Whenever a base station is involved in a channel management scenario, it should preferably transmit an addressed message on the channel (CHa or CHb) on which it last received a message from the relevant addressed station.

Generally, according to the self-organizing transmission algorithm, when a station selects a new time slot for transmission of data, the station should select a time slot from a set of candidate time slots within a so-called selection interval Si. FIG. 4 shows such a selection interval Si, which includes twelve future time slots s₁-s₁₂ with respect to a current time slot 410. The position of the selection interval Si in relation to the current time slot 410 typically depends on a nominal increment between two consecutive transmissions of a periodic message. The principles behind the nominal increments are however outside the scope of this invention and will therefore not be discussed here.

When the set of candidate time slots includes less than four time slots, the station should intentionally reuse time slots, i.e. utilize one or more time slots that are actually allocated to a different station, such that the number of time slots in the set of candidate time slots (ideally) becomes equal to four. Preferably, if the station itself is ship borne, the station should only reuse time slots that are allocated to other ship borne stations. However, time slots may never be reused from stations which indicate that no time slots are available. Consequently, under unfavorable conditions, the set of candidate time slots may still include less than four time slots.

Preferably, the algorithm prescribes that in case of intentional reuse of time slots, these slots within the selection interval SI should primarily be taken from the most distant stations. Further considerations regarding selection priorities when intentionally reusing time slots will become apparent from the example discussed below with reference to FIG. 4.

Moreover, according to a preferred embodiment of the invention, a station is only permitted to reuse a time slot that is allocated to a base station if the base station is located outside a threshold distance from the station. However, the station may reuse a time slot that is allocated to a mobile station, which is located at any distance from the station. In any case, when a station has been subject to intentional reuse of a time slot, that station should be excluded from further intentional time slot reuse during a particular time period, e.g. equivalent to the duration of a frame D_{F} (see FIG. 1b).

The letters in the time slots s₁-S₁₂ of the channels CHa and CHb of FIG. 4 designate the following conditions:
F Free
I Internally allocated by own station (however not in use now)
E Externally allocated by another station near the own station
B Allocated by a base station within a threshold distance from the own station,
T Allocated to another station that has not been received within a particular (relatively long) time period,
D Allocated by the most distant station,
O Internally allocated by own station (presently in use)
X Should not be used

In this example, a station is presumed to use the channel CHa and to be in the process of selecting a time slot within the selection interval SI (including the time slots s₁-s₁₂). A time slot will here be selected according to the priority order: s₅, s₂, s₃, s₅, s₆, s₇ and s₈. I.e. the time slot s₁ has the highest priority of being selected and the time slot s₇ has the lowest priority of being selected. The reason for this priority order is that: s₁-s₃ are all free and may thus be used directly without any further considerations; s₅ and s₆ are “psuedo” free, i.e. not formally free, however these time slots may most probably be used without infringing any reservations made by other stations; s₇; and s₈ are de facto already allocated to other stations, however due to the distance between the current station and these stations, the time slots s₇ and s₈ can here be reused with a comparatively high probability of success (e.g. avoiding co-channel interference).

Nevertheless, none of the time slots s₄, s₉, s₁₀, s₁₁ or s₁₂ can be used. The rationale behind this is that: s₄ is allocated by another station on the channel CHb, and this other station is located geographically near the current station; s₉ is an adjacent time slot to a time slot s₁₀ on the channel CHb, which is presently in use by the current station itself (Namely, the station cannot switch between the channel CHa and the channel CHb from one time slot to another. Such frequency transitions requires a time period which approximately corresponds to the duration of one time slot.); s₁₀ is an opposite time slot to a time on the channel CHb, which is presently in use by the current station itself; s₁₁ simply should not be used (Moreover, the time slot s₁₁ cannot be used because of the adjacent slot rule.); and s₁₂ should not be used because it is allocated by a base station within a threshold distance Dₜₕ from the own station. According to a preferred embodiment of the invention, the threshold distance Dₜₕ represents 120 nautical miles.

As mentioned initially, the asymmetry caused by the time slot s₁₂ being used by the base station and the fact that a mobile station cannot reuse this time slot s₁₂ may result in that an addressed message originated by the base station may reach the mobile station, whereas a corresponding acknowledge message from the mobile station to the base station cannot be sent.

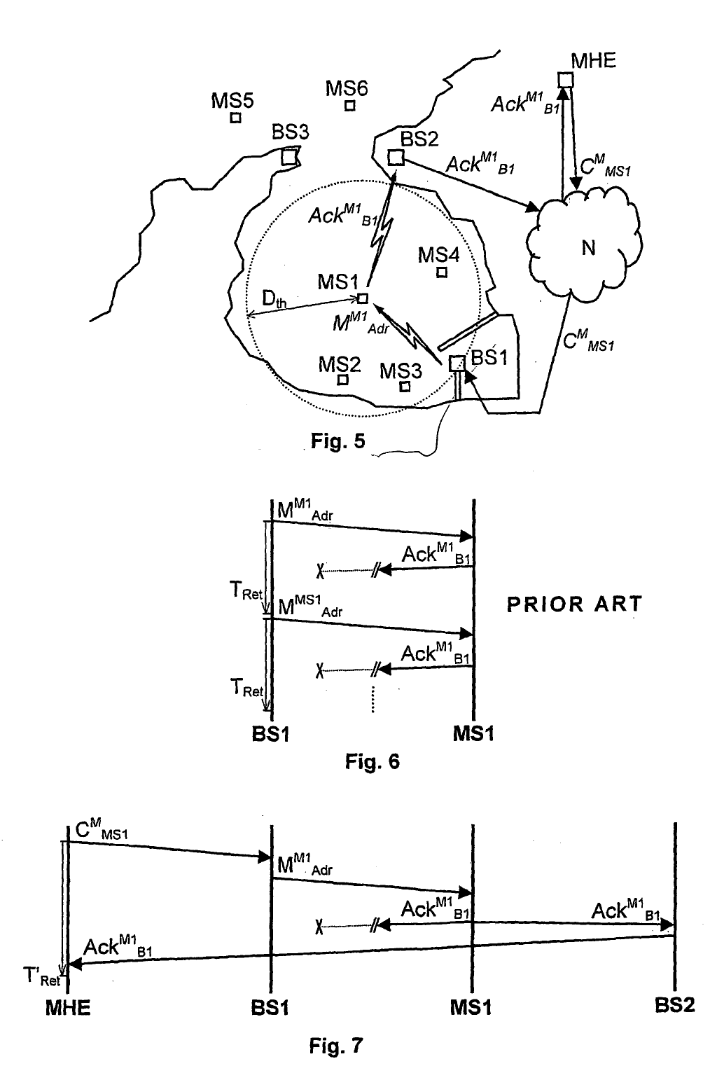

FIG. 5 shows a terrain segment in which a plurality of stations MS1-MS6 and BS1-BS3 respectively in an SOTDMA-system communicate according to a self-organizing transmission algorithm, which allows a first station to reuse a time slot that is allocated to a second station as described above, however, does not suffer from the asymmetry problem.

In this example, a first base station BS1 is located in proximity to a naval harbor at which a comparatively large number of vessels call. Each of these vessels are presumed to be associated with a particular mobile station MS1-MS4. A second and a third base station BS2 and BS3 respectively are located on each side of an entrance to a bay outside the harbor. Thus together, the base stations BS1-BS3 may efficiently serve any mobile stations MS1-MS6 which enter the bay area.

A message handling entity MHE constitutes a separate node in a network N to which at least the first base station BS1 and the second base station BS2 are connected. The message handling entity MHE is responsible for the delivery of addressed messages to mobile stations via at least the first and the second base stations BS1 and BS2 respectively. Whenever an addressed message is to be transmitted to a mobile station via any of these base stations BS1; BS2, the message handling entity MHE sends a control message to an appropriate base station through the network N. The network N may involve arbitrary transmission technologies and formats, including for example, electric cables, optical fibers and microwave links.

In this example, the message handling entity MHE sends a control message C^{M}_{MS1} to the first base station BS1 in order to cause an addressed message to be transmitted to a first mobile station MS1. In response to this message C^{M}_{MS1}, the first base station BS1 transmits an addressed message M^{M1}_{Adr} to the mobile station MS1. It is presumed that, due to a high traffic load in the area immediately outside the harbor where the first mobile station MS1 is located, this station MS1 cannot transmit an acknowledgement message Ack^{M1}_{B1} in response to the addressed message M^{M1}_{Adr} without reusing a time slot that is allocated to another station. Moreover, the first base station BS1 is located within a threshold distance Dₜₕ from the first mobile station MS1. Consequently, the station MS1 cannot reuse a time slot being allocated to the first base station BS1 either. Therefore, it is here presumed that the first mobile station MS1 is completely barred from transmitting the acknowledgement message Ack^{M1}_{B1} directly to the first base station BS1 and thus indicate a safe receipt of the addressed message M^{M1}_{Adr}. Instead, the acknowledgement message Ack^{M1}_{B1} reaches the second base station BS2. This station BS2 forwards the acknowledgement message Ack^{M1}_{B1} via the network N to the message handling entity MHE. Thereby, the message handling entity MHE is informed that the addressed message M^{M1}_{Adr} was received correctly by the first mobile station MS1. Consequently, no retransmissions of this message M^{M1}_{Adr} are necessary.

According to a preferred embodiment of the invention, the first base station is positioned on a relatively high altitude, such that its radio range (or line of sight) becomes comparatively long. The second and third base stations BS2 and BS3 respectively, may however be positioned on lower altitudes. Thereby, the first base station BS1 will primarily function as a transmitting station, whereas the second and third base stations BS2; BS3 will mainly serve a listening purpose, i.a. by receiving acknowledgement messages relating to addressed messages that have been sent by the first base station BS1.

FIG. 6 shows a sequence diagram, which addresses a problem that is associated with a prior-art solution. Namely, had the first mobile station MS1 (in FIG. 5) not been able to send its acknowledgement message Ack^{M1}_{B1} via the second base station BS2 to the first base station BS1, a retransmission timer T_{Ret} would have expired before the acknowledgement message Ack^{M1}_{B1} had reached the first base station BS1. As a further consequence, the first base station BS1 would have retransmitted the addressed message M^{M1}_{Adr} to the first mobile station MS1 (even though this, in fact, was unnecessary). The retransmission timer T_{Ret} would again expire and the first base station BS1 would retransmit the addressed message M^{M1}_{Adr} once more, and so on, until the addressed message M^{M1}_{Adr} had been retransmitted a maximum number of times, say four. Naturally, such procedure is not only unnecessary, it also consumes valuable transmission resources that could have been used more prudently.

FIG. 7 shows a sequence diagram corresponding to that of FIG. 6, however where a first strategy according to an aspect of the invention is applied.

A message handling entity MHE is here responsible for the delivery of an addressed message M^{M1}_{Adr} to a mobile station MS1. In order to effectuate this delivery the message handling entity MHE sends a control message C^{M}_{MS1} to a first base station BS1. In response to the control message C^{M}_{MS1}, the first base station BS1 transmits the addressed message M^{M1}_{Adr} to the mobile station MS1. Again, it is presumed that the first mobile station MS1 cannot send its acknowledgement message Ack^{M1}_{B1} (indicating a safe receipt of the addressed message M^{M1}_{Adr}) directly to the first base station BS1. Nevertheless, the acknowledgement message Ack^{M1}_{B1} reaches a second base station BS2. This station BS2 then forwards the acknowledgement message Ack^{M1}_{B1} to the message handling entity MHE, such that it arrives there before a retransmission timer T′_{Ret} expires. Thereby, the message handling entity MHE can refrain from ordering any retransmissions of the addressed message M^{M1}_{Adr} from the first base station BS1.

FIG. 8 shows a block diagram over a proposed message handling entity MHE for controlling data communication between at least one base station and at least one mobile station in a time division multiple access system, where the data is transmitted wirelessly between the stations in time slots according to the principles described above. The message handling entity MHE includes a central unit 840, a memory area 850 and an interface 860 towards a network. The memory area 850 is adapted to hold status information pertaining to addressed messages that are transmitted from each base station in respect of which the message handling entity MHE is responsible for the communication of such messages to mobile stations.

The interface 860 is adapted to send a control message C^{M}_{MS1}, which orders a certain base station (e.g. the first base station BS1 in FIG. 5) to transmit an addressed message to a particular mobile station (e.g. the first mobile station MS1 in FIG. 5). The interface 860 is also adapted to receive acknowledgement messages Ack^{M1}_{B1} in respect of any addressed messages that have been originated from a base station in respect of which the message handling entity MHE is responsible for the communication of such messages. According to the invention, it is irrelevant whether a received acknowledgement message Ack^{M1}_{B1} reaches the message handling entity MHE via the same base station that transmitted the corresponding addressed message, or if such message Ack^{M1}_{B1} reaches the message handling entity MHE via a different base station (e.g. the second base station BS2 in FIG. 5). Finally, the interface 860 is adapted to forward the received acknowledgement messages Ack^{M1}_{B1} for further processing in the central unit 840.

The central unit 840 is adapted to receive the acknowledgement messages Ack^{M1}_{B1} from the interface 860, and in response thereto, clear the corresponding status information in the memory area 850. The central unit 840 is also adapted to order retransmission of an addressed message from a base station (e.g. the first base station BS1 in FIG. 5), if after a predetermined interval from a prior transmission of the addressed message, the status information remains intact in the memory area 850 (because a corresponding acknowledgement messages Ack^{M1}_{B1} has not been received). However preferably, such retransmission orders should only be repeated a maximum number of times.

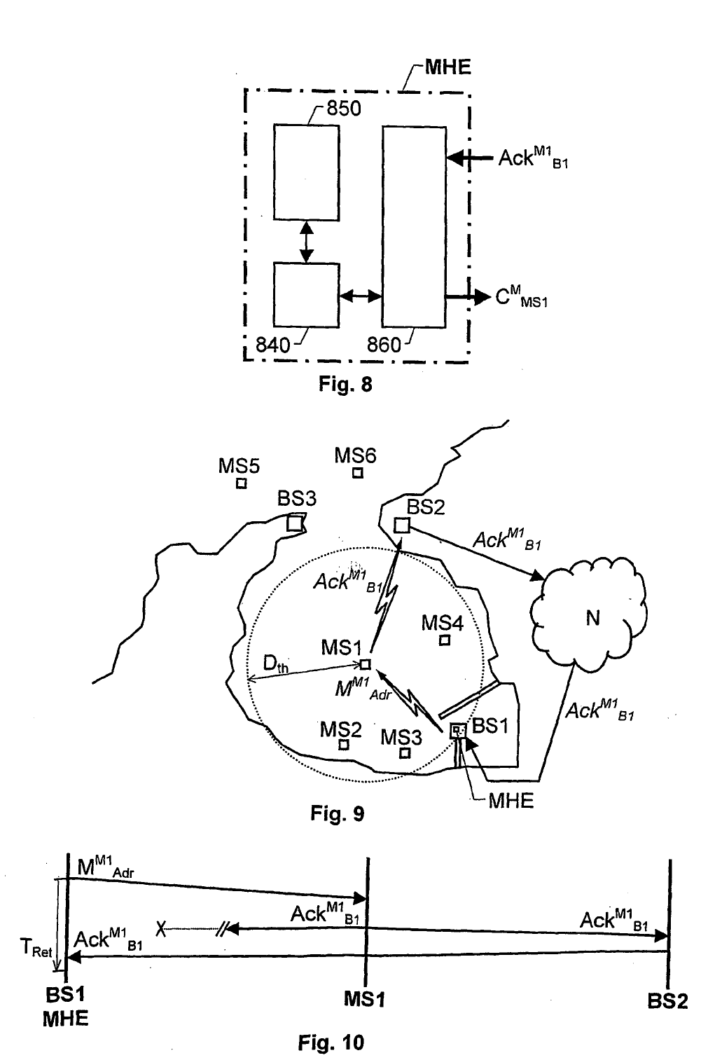

FIG. 9 shows a terrain segment in which a plurality of stations MS1-MS6 and BS1-BS3 respectively in an SOTDMA-system communicate according to a self-organizing transmission algorithm, which allows a first station to reuse a time slot that is allocated to a second station as described above.

A first base station BS1 is located in proximity to a naval harbor at which a comparatively large number of vessels call. Each of these vessels are presumed to be associated with a particular mobile station MS1-MS4. A second and a third base station BS2 and BS3 respectively are located on each side of an entrance to a bay outside the harbor. Thus together, the base stations BS1-BS3 may efficiently serve any mobile stations MS1-MS6 which enter the bay area. A network N interconnects the first base station BS1 and the second base station BS2. Preferably, the network N also includes one or more other nodes, such as additional base stations, for instance the third base station BS3. The network N may involve arbitrary transmission technologies and formats, including for example, electric cables, optical fibers and microwave links.

Here, the first base station BS1 includes a message handling entity MHE and is hence responsible for the delivery of addressed messages to mobile stations via the first base station BS1. In this example the first base station BS1 transmits an addressed message M^{M1}_{Adr} to a first mobile station MS1. Due to the high traffic load in the area immediately outside the harbor where the first mobile station MS1 is located, this station MS1 cannot transmit an acknowledgement message Ack^{M1}_{B1} in response to the addressed message M^{M1}_{Adr} without reusing a time slot that is allocated to another station. Moreover, the first base station BS1 is located within a threshold distance Dₜₕ from the first mobile station MS1. Consequently, the station MS1 cannot reuse a time slot being allocated to the first base station BS1 either. Therefore, it is here presumed that the first mobile station MS1 is completely barred from transmitting the acknowledgement message Ack^{M1}_{B1} to the first base station BS1. However, such an acknowledgement message Ack^{M1}_{B1} is instead received by the second base station BS2, which experiences a somewhat lower traffic load.

According to the invention, the second base station BS2 forwards the acknowledgement message Ack^{M1}_{B1} to the message handling entity MHE in the first base station BS1 via the network N. Thereby, the message handling entity MHE is informed that the addressed message M^{M1}_{Adr} was received correctly by the first mobile station MS1. Consequently, the first base station BS1 can refrain from performing any retransmissions of this message M^{M1}_{Adr}.

According to a preferred embodiment of the invention, the first base station is positioned on a relatively high altitude, such that its radio range (or line of sight) becomes comparatively long. The second and third base stations BS2 and BS3 respectively, may however be positioned on lower altitudes. Thereby, the first base station BS1 will primarily function as a transmitting station, whereas the second and third base stations BS2; BS3 will mainly serve a listening purpose, i.a. by receiving acknowledgement messages relating to addressed messages that have been sent by the first base station BS1.

FIG. 10 shows a sequence diagram, which exemplifies a strategy of the invention according to the embodiment of the invention exemplified in FIG. 9. Thus, the message handling entity MHE being responsible for the delivery of an addressed message M^{M1}_{Adr} to a mobile station MS1 is included in the first base station BS1 from which the addressed message M^{M1}_{Adr} is transmitted to the mobile station MS1.

In similarity with the situation discussed above with reference to FIG. 7, it is presumed that the mobile station MS1 cannot send its acknowledgement message Ack^{M1}_{B1} directly to a first base station BS1 (i.e. the station from which an addressed message M^{M1}_{Adr} was been originated). Nevertheless, the acknowledgement message Ack^{M1}_{B1} from the mobile station MS1 reaches the second base station BS2. This station BS2 then forwards the acknowledgement message Ack^{M1}_{B1} to the first base station BS1, such that it arrives there before the retransmission timer T_{Ret} expires. Hence, the first base station BS1 will not perform any retransmissions of the addressed message M^{M1}_{Adr}.

FIG. 11 shows a block diagram over a proposed base station BS1 for communicating data with at least one other station in a time division multiple access system where the data is transmitted wirelessly between the stations in time slots. The time slots are further presumed to be organized in frames of a repeating frame structure and the stations select time slots for transmission of data according to a self-organizing transmission algorithm, which allows a first station to reuse a time slot that is allocated to a second station according to the principles discussed above.

The base station BS1 includes a transmitter 1110, a receiver 1120, a central unit 1140, a memory area 1150 and an interface 1160 towards a fixed connection with at least one other base station, such as BS2 in FIG. 9. The base station BS1 also includes an antenna 1135 and preferably a signal selector 1130 for exchanging radio energy with other stations and switching the corresponding radio signals transmitted from the transmitter 1110 to the antenna, respective between received via the antenna 1135 and fed to the receiver 1120.

The transmitter 1110 is adapted to transmit an addressed message M^{M1}_{Adr} to a mobile station. The memory area 1150 is adapted to hold status information pertaining to the addressed message M^{M1}_{Adr}, such that the base station BS1 may keep track of whether an acknowledgement message Ack^{M1}_{B1} has been received in respect of the addressed message M^{M1}_{Adr} or not. The receiver 1120 is adapted to receive any incoming acknowledgement messages Ack^{M1}_{B1} that are generated in response to the addressed message M^{M1}_{Adr} and sent to the base station BS1 over the air, (i.e. entering the base station BS1 via the antenna 1135). The receiver 1120 is also adapted to forward the acknowledgement message Ack^{M1}_{B1} for further processing in the base station BS1, for instance in the central unit 1140.

The central unit 1140, in turn, is adapted to retransmit the addressed message M^{M1}_{Adr} to mobile station if, after a predetermined interval from the transmission of the addressed message M^{M1}_{Adr}, the status information in the memory area 1150 remains intact. Nevertheless, the central unit 1140 will only repeat the retransmission a maximum number of times. Finally, the central unit 1140 is adapted to receive the acknowledgement message Ack^{M1}_{B1}, either from the receiver 1120 or via the interface 1160, and in response thereto, clear the status information in the memory area 1150 (thus preventing any further retransmissions of the addressed message M^{M1}_{Adr}).

The interface 1160 is adapted to receive acknowledgement messages Ack^{M1}_{B1} from the at least one other base station, say BS2, and forward such messages to the central unit 1150.

According to a preferred embodiment of the invention, the receiver 1120 is also adapted to receive acknowledgement messages Ack^{M4}_{B2} in respect of at least one other base station, such as an acknowledgement message generated by a mobile station MS4 in response to an addressed message from the second base station BS2 in FIG. 9. This acknowledgement message Ack^{M4}_{B2} is then advanced to the interface 1160, which is further adapted to forward the message Ack^{M4}_{B2} to the at least one other base station.

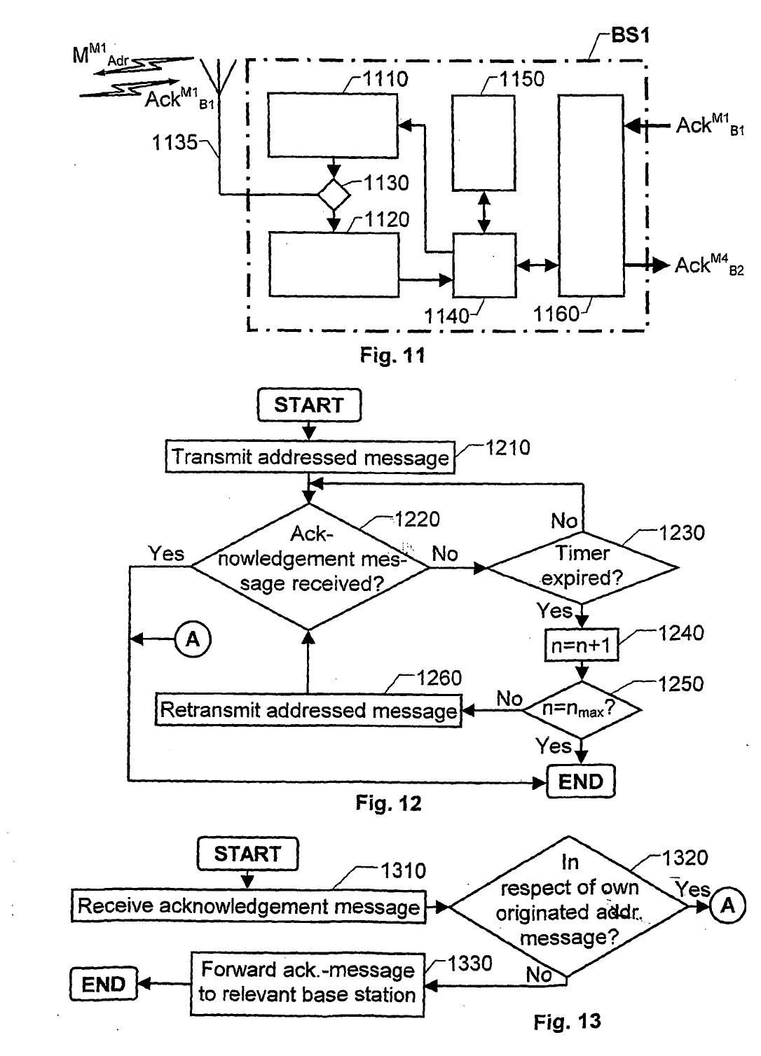

In order to sum up, a first aspect of the general method for communicating data according to the invention will now be described with reference to FIG. 12.

A first step 1210 transmits an addressed message to a mobile station. A step 1220 then investigates whether a corresponding acknowledgement message has been received, and if so, the procedure ends. Otherwise, a step 1230 checks if a timer that represents a retransmission interval has expired, and if so, a step 1240 follows. Otherwise, the procedure loops back to the step 1220 again.

The step 1240 increments a counter by one, whereafter a step 1250 checks if the counter has reached a limit value nₘₐₓ representing a maximum number of retransmissions. If the limit value nₘₐₓ has been reached the procedure ends. Otherwise, a subsequent step 1260 retransmits the addressed message and the procedure returns to the step 1220.

A second aspect of the general method for communicating data according to the invention is described below with reference to FIG. 13.

A first step 1210 receives an acknowledgement message. Subsequently, a step 1220 investigates whether the acknowledgement message pertains to an addressed message that was originated by the base station itself, or if instead the addressed message was sent from a different base station. In the former case, the procedure ends via a path A to the flow diagram of FIG. 12, and in the latter case, a final step 1230 forwards the acknowledgement message to the relevant base station.

All of the process steps, as well as any sub-sequence of steps, described with reference to the FIGS. 12 and 13 above may be controlled by means of a programmed computer apparatus, preferably located in a base station. Moreover, although the embodiments of the invention described above with reference to the drawings comprise computer apparatus and processes performed in computer apparatus, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The carrier may be any entity or device capable of carrying the program. For example, the carrier may comprise a storage medium, such as a ROM (Read Only Memory), for example a CD (Compact Disc) or a semiconductor ROM, or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1. A method for communicating data in a time division multiple access system where the data is transmitted wirelessly between stations in time slots, the time slots being organized in frames of a repeating frame structure, the stations selecting time slots for transmission of data according to a self organizing transmission algorithm which allows a first station to reuse a time slot that is allocated to a second station, the method involving comprising:
transmitting an addressed message from a first base station to a mobile station,
transmitting, in response to the addressed message, an acknowledgement message from the mobile station, and
repeating the transmission of the addressed message from the first base station to the mobile station until either a message handling entity being responsible for the transmission of the addressed message has received the acknowledgement message or a maximum number of retransmissions has been performed,
receiving the acknowledgement message in a second base station,
forwarding the acknowledgement message from the second base station to the message handling entity, the message handling entity being connected to a network to which both the first base station and the second base station are connected, either directly or via at least one intermediate node, and
receiving the acknowledgement message in the message handling entity via the network.

2. A method according to claim 1, further comprising forwarding the acknowledgement message via the network to the message handling entity within the first base station.

3. A method according to claim 1, further comprising forwarding the acknowledgement message via the network to a node in the network which is separated from the first base station.

4. A method according to claim 1, wherein the self-organizing transmission algorithm permits only the first station to reuse a time slot allocated to a base station if the base station is located outside a threshold distance from the first station.

5. A method according to claim 4, wherein the self-organizing transmission algorithm permits the first station to reuse a time slot allocated to a mobile station that is located at any distance from the first station.

6. A method according to claim 1, wherein the first station is a mobile station.

7. A computer program directly loadable into the internal memory of a digital computer, comprising software for accomplishing the steps of claim 1 when said program is run on a computer.

8. A computer readable medium, having a program recorded thereon, where the program is to make a computer accomplish the steps recited in claim 1.

9. A message handling entity for controlling data communication between at least one base station and at least one mobile station in a time division multiple access system where the data is transmitted wirelessly between the stations in time slots, the time slots are organized in frames of a repeating frame structure the stations select time slots for transmission of data according to a self-organizing transmission algorithm which allows a first station to reuse a time slot that is allocated to a second station, comprising:
a memory area adapted to hold status information pertaining to an addressed message sent from a first base station to a particular mobile station,
an interface towards a network adapted to
send a control message ordering the first base station to transmit an addressed message to the mobile station,
receive an acknowledgement message from a second base station, the acknowledgement message having been generated by the mobile station in response to the addressed message and sent to the second base station, and
forward the acknowledgement message for processing in the message handling entity, and a central unit adapted to
order retransmission of the addressed message from the first base station, if after a pre-determined interval from the transmission of the addressed message, the status information remains intact in the memory area,
order repeated retransmission a maximum number of times, and
receive the acknowledgement message, and in response thereto, clear the status information in the memory area.

10. A base station for communicating data with at least one other station in a time division multiple access system where the data is transmitted wirelessly between the stations in time slots, the time slots are organized in frames of a repeating frame structure, the stations select time slots for transmission of data according to a self-organizing transmission algorithm which allows a first station to reuse a time slot that is allocated to a second station, comprising
a transmitter adapted to transmit an addressed message to a mobile station,
a memory area adapted to hold status information pertaining to the addressed message,
a receiver adapted to
receive an acknowledgement message generated by the mobile station in response to the addressed message, and
forward the acknowledgement message for processing in the base station, and a central unit adapted to
retransmit the addressed message, if after a predetermined interval from the transmission of the addressed message, the status information remains intact in the memory area, repeat the retransmission a maximum number of times, and
receive the acknowledgement message, and in response thereto, clear the status information in the memory area, and
an interface towards a network to which at least one other base station is connected, the interface being adapted to receive acknowledgement messages from the at least one other base station and forward any such messages to the central unit.

11. A base station according to claim 10, wherein the receiver is adapted to receive acknowledgement messages in respect of at least one other base station, and the interface is further adapted to forward acknowledgement messages received in respect of the at least one other base station to the respective at least one other base station via the network.
